(19) United States
(12) Patent Application Publication
(10) Pub. No.: US 2019/0259509 A1
(43) Pub. Date: Aug. 22, 2019

(54) ION EXCHANGE MEMBRANE AND METHOD OF PRODUCING SAME, MEMBRANE ELECTRODE ASSEMBLY, AND REDOX FLOW BATTERY

(71) Applicant: 3M INNOVATIVE PROPERTIES COMPANY, St Paul, MN (US)

(72) Inventors: Kazuki NODA, Tokyo (JP); Yuji HIROSHIGE, Tokyo (JP)

(21) Appl. No.: 16/307,553

(22) PCT Filed: Jun. 15, 2017
(86) PCT No.: PCT/US2017/037688

§ 371 Date: Dec. 6, 2018

(30) Foreign Application Priority Data
Jun. 17, 2016 (JP) 2016-120944

(51) Int. Cl. H01B 1/12; C08J 5/22; H01M 8/1044; H01M 8/18

(52) U.S. Cl. CPC H01B 1/122; C08J 5/2262; C08J 2371/02; H01M 8/1044; H01M 8/188; H01B 1/125

(57) ABSTRACT

Object: To provide an ion exchange membrane which can achieve both high proton transport ability and high ion permeation selectivity, a membrane-electrode assembly including said ion exchange membrane, and a redox flow battery including said membrane-electrode assembly. Resolution Means: One aspect of the present disclosure provides an ion exchange membrane for a redox flow battery including an ion-conductive polymer and a non-woven fabric, wherein the non-woven fabric is disposed in the ion-conductive polymer. Another aspect of the present disclosure provides a membrane-electrode assembly including a positive electrode, a negative electrode, and the ion exchange membrane for a redox flow battery of the present disclosure, wherein the ion exchange membrane for a redox flow battery is disposed between the positive electrode and the negative electrode. Another aspect of the present disclosure provides a redox flow battery including a membrane-electrode assembly of the present disclosure. Yet another aspect of the present disclosure provides a method for producing an ion exchange membrane for a redox flow battery.

### TECHNICAL FIELD

The present disclosure relates to an ion exchange membrane and a method for producing the same, a membrane-electrode assembly, and a redox flow battery.

### BACKGROUND ART

In general, a redox flow battery includes a positive cell containing a positive electrolyte solution and a positive electrode, a negative cell containing a negative electrolyte solution and a negative electrode, and an ion exchange membrane that is arranged to separate the positive cell and the negative cell. The positive electrolyte solution and the negative electrolyte solution are supplied from respective tanks to each of the positive cell and the negative cell, and circulated back to the respective tanks after oxidation reaction (in the positive cell) and reduction reaction (in the negative cell) have been performed. In the redox flow battery, the positive electrolyte solution and the negative electrolyte solution can include a metal ion of the same kind. For example, in a vanadium-type redox flow battery, a combination of the positive electrolyte solution and the negative electrolyte solution is used, where the positive electrolyte solution is a sulfate solution containing tetravalent and pentavalent vanadium and the negative electrolyte solution is a sulfate solution containing divalent and trivalent vanadium. During charging, the tetravalent vanadium is oxidized to the pentavalent vanadium at the positive electrode and the trivalent vanadium is reduced to the divalent vanadium at the negative electrode. During discharging, the reaction reverse to the reaction above occurs. The ion exchange membrane is required to allow protons to permeate from the positive cell to the negative cell while separating the positive electrolyte solution and the negative electrolyte solution. On the other hand, it is desirable that the ion exchange membrane does not essentially allow metal ions in the electrolyte solution to permeate through. However, the metal ion permeation described above (i.e. “crossover”) may become problematic in a conventional ion exchange membrane. Especially, the issue of the permeation of a vanadium ion is significant in the vanadium-type redox flow battery described above. Permeation of the metal ions through the ion exchange membrane causes the decrease in the current efficiency (i.e. a ratio of an electric power that can be actually obtained to the electric power that is stored).

Patent Document 1 describes a redox flow rechargeable battery including a electrolysis tank, which includes a positive cell compartment including a positive electrode including a carbon electrode, a negative cell compartment including a negative electrode including a carbon electrode, and an electrolyte membrane as a separating membrane isolating and separating the positive cell compartment and the negative cell compartment, where the positive cell compartment includes a positive electrolyte solution containing an active material and the negative cell compartment includes a negative electrolyte solution containing an active material, and the rechargeable battery can charge and discharge based on a valence change of the active material in the electrolyte solution. The electrolyte membrane includes an ion-exchange resin composition, whose main component is a fluoropolymer electrolyte polymer having a structure represented by Formula (1) (not shown herein), and has a multilayer structure of three layers or more. In the redox flow battery, water content at equilibrium of an outer layer adjacent to the positive electrode and the negative electrode is greater than water content at equilibrium of a middle layer that is not adjacent to any one of the positive electrode and the negative electrode.

Patent Document 2 describes a liquid-circulation-type battery, in which a positive electrode and a negative electrode, including a liquid-permeating porous carbon electrode, are separated by a separating membrane and a redox reaction is performed by passing a positive electrode solution and a negative electrode solution to the positive electrode and the negative electrode, thus, the battery can charge and discharge. In such a battery, the separating membrane includes an ion exchange membrane that fulfills (1) below and the positive electrode solution and the negative electrode solution include an electrolyte solution that fulfills (2) below.

(1) An ion exchange membrane including a polymer thin membrane, in which a halogenated alkyl material of the aromatic polysulfone-type polymer having a structure represented by the Formula I (not shown herein) is crosslinked by polyamine, as an ion exchange body layer, wherein an ion exchange capacity of the polymer thin membrane is from 0.3 to 0.8 milliequivalent/(gram of a dried resin) and a thickness is from 0.1 to 120 μm;

(2) A concentration of vanadium ions is from 0.5 to 8 mol/L.

Patent Document 3 describes a redox flow rechargeable battery including a electrolysis tank, which includes a positive cell compartment including a positive electrode including a carbon electrode, a negative cell compartment including a negative electrode including a carbon electrode, and an electrolyte membrane as a separating membrane isolating and separating the positive cell compartment and the negative cell compartment, where the positive cell compartment includes a positive electrolyte solution containing a positive electrode active material and the negative cell compartment includes a negative electrolyte solution containing a negative electrode active material, and the rechargeable battery can charge and discharge based on a valence change of the positive electrode active material and the negative electrode active material in the electrolyte solution. The electrolyte membrane includes an ion-exchange resin composition, which includes a fluoropolymer electrolyte polymer having a structure represented by Formula (1) (not shown herein), and an ion cluster size of the electrolyte membrane measured by the small-angle X-ray method in 25° C. water is from 1.00 to 2.95 nm.

### CITATION LIST

### Patent Literature

Patent Document 1: Japanese Unexamined Patent Application Publication No. 2013-168365A

Patent Document 2: Japanese Unexamined Patent Application Publication No. H9-223513A

Patent Document 3: WO 2103/100079

### SUMMARY OF INVENTION

### Technical Problem

If an ion-conductive polymer is used as an ion exchange membrane in a redox flow battery, an energy loss during charge/discharge (i.e. cell resistance) decreases as a proton transport ability of the ion exchange membrane is better. The current efficiency (i.e. the ratio of the electrical power actually obtained to the electrical power stored) is higher for an ion exchange membrane having a higher permeation selectivity of an ion (typically a cation). Therefore, the use of an ion exchange membrane that has both high proton transport ability and high ion permeation selectivity simultaneously can advantageously facilitate achieving both low cell resistivity and high current efficiency in a redox flow battery.

However, an ion-conductive polymer having a larger number of ion-conductive groups is advantageous for achieving the high proton transport ability, while an ion-conductive polymer having a smaller number of ion-conductive groups is advantageous for achieving the high ion permeation selectivity, if an ion-conductive polymer is used. Thus, it was difficult to obtain an ion exchange membrane that has both high proton transport ability and high ion permeation selectivity simultaneously.

An object of the present invention is to solve the above problems and to provide an ion exchange membrane which can achieve both high proton transport ability and high ion permeation selectivity simultaneously and a method for producing the same; a membrane-electrode assembly including said ion exchange membrane; and a redox flow battery including said membrane-electrode assembly.

### Solution to Problem

One aspect of the present disclosure provides an ion exchange membrane for a redox flow battery including an ion-conductive polymer and a non-woven fabric, wherein said non-woven fabric is disposed in said ion-conductive polymer.

Another aspect of the present disclosure provides a membrane-electrode assembly including a positive electrode, a negative electrode, and the ion exchange membrane for a redox flow battery of the present disclosure, wherein the ion exchange membrane for a redox flow battery is disposed between said positive electrode and said negative electrode.

Another aspect of the present disclosure provides a redox flow battery including the membrane-electrode assembly of the present disclosure, wherein said redox flow battery includes a positive cell containing a positive electrolyte solution and said positive electrode, a negative cell containing a negative electrolyte solution and said negative electrode, and said ion exchange membrane separates said positive cell and said negative cell.

Another aspect of the present disclosure provides a method for producing an ion exchange membrane for a redox flow battery including:

preparing a multilayer member including a first ion-conductive polymer, a second ion-conductive polymer and a non-woven fabric comprising a non-ion-conductive polymer, wherein the non-woven fabric is disposed between the first ion-conductive polymer and the second ion-conductive polymer; and

forming an ion exchange membrane by subjecting said multilayer member to

(i) a temperature higher than a glass transition temperature of said first ion-conductive polymer,

(ii) a temperature higher than a glass transition temperature of said second ion-conductive polymer, or

(iii) a temperature higher than both of a glass transition temperature of said first ion-conductive polymer and a glass transition temperature of said second ion-conductive polymer.

### Advantageous Effects of Invention

According to an embodiment of the present invention, an ion exchange membrane which can achieve both high proton transport ability and high ion permeation selectivity simultaneously and a method for producing the same; a membrane-electrode assembly including said ion exchange membrane; and a redox flow battery including said membrane-electrode assembly are provided.

### BRIEF DESCRIPTION OF DRAWINGS

FIG. 1 is an illustration of a membrane-electrode assembly according to one aspect of the present invention.

FIGS. 2A and 2B are illustrations of non-woven fabrics used in Examples. FIG. 2A illustrates the non-woven fabric 1 and FIG. 2B illustrates the non-woven fabric 4.

### DESCRIPTION OF EMBODIMENT

An exemplary aspect of the present invention will now be described, but the present invention is not limited thereto. An ion exchange membrane for a redox flow battery of the present disclosure may be referred to as “ion exchange membrane” hereinafter. Unless otherwise noted, a characteristic value described in the present disclosure is intended to be a value measured with the method described in the Examples section or a method that would be understood to be equivalent thereto by a person having ordinary skill in the art.

Ion exchange membrane for redox flow battery One aspect of the present disclosure provides an ion exchange membrane for a redox flow battery including an ion-conductive polymer and a non-woven fabric, wherein said non-woven fabric is disposed in said ion-conductive polymer.

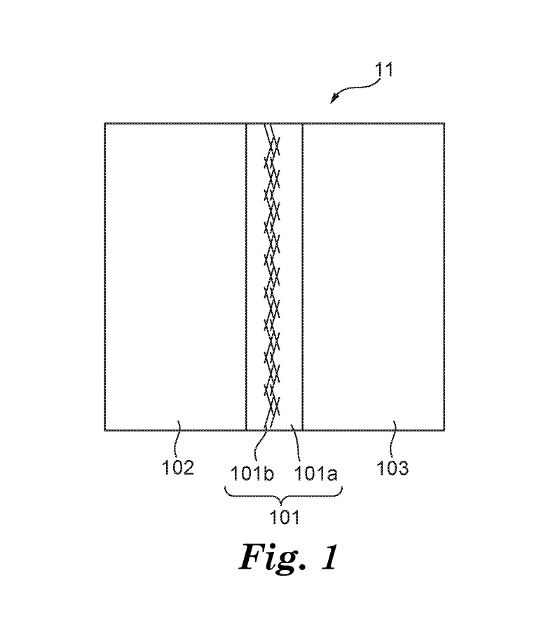

As illustrated in FIG. 1, an ion exchange membrane 101 for a redox flow battery includes an ion-conductive polymer 101a and a non-woven fabric 101b which is disposed in said ion-conductive polymer 101a. The non-woven fabric is substantially porous because it is a fiber sheet. The ion-conductive polymer is present in pores between fibers in the non-woven fabric, thus the ion exchange membrane allows protons to be transported in the thickness direction.

An ion-conductive polymer generally may experience swelling under the presence of water as described below, but the polymer of the non-woven fabric generally does not swell in the presence of water. If swelling is suppressed, the ion-conductive polymer can contribute to superior ion permeation selectivity. Particularly, in a typical aspect, while the ion-conductive groups in the ion-conductive polymer are considered to form a cluster to contribute to formation of a path for transporting protons, the non-woven fabric contributes to better retention of the clusters by suppressing relaxation of said clusters due to swelling of the ion-conductive polymer. On the other hand, because the non-woven fabric is disposed in the ion-conductive polymer (i.e. the non-woven fabric is present only in a partial region of the ion-conductive polymer in the thickness direction), the non-woven fabric would not degrade the proton transport ability of the ion exchange membrane greatly. Thus, the ion exchange membrane according to an aspect of the present disclosure can realize both high proton transport ability and high ion permeation selectivity at the same time. By using such an ion exchange membrane, energy efficiency can be improved without increasing the cell resistivity greatly in a redox flow battery.

In a preferred aspect, the thickness of the ion exchange membrane is not less than approximately 10 μm, or not less than approximately 15 μm, or not less than approximately 20 μm from the viewpoint of high ion permeation selectivity, and not greater than approximately 100 μm, or not greater than approximately 50 μm, or not greater than approximately 30 μm, or not greater than approximately 25 μm from the viewpoint of high proton transport ability.

In the present disclosure, the mechanical strength of the non-woven fabric may be smaller than the mechanical strength of a non-woven fabric used to reinforce an ion-conductive polymer. In other words, the non-woven fabric is not used to reinforce the ion-conductive polymer. In one embodiment, Young's modulus of the ion exchange membrane of the present disclosure may be not greater than approximately 400 MPa, or not greater approximately 300 MPa, or not greater than approximately 200 MPa. In one embodiment, the non-woven fabric has a basis weight of less than 3.5 grams of fabric per square meter, less than 3.0 g/m², less than 2.5 g/m², or even less than 2.0 g/m². Since density of the fiber can impact basis weight, in one embodiment, when the fiber has a density greater than 1.7 g/m², the basis weight of the non-woven fabric is less than 3.5 g/m², less than 3.0 g/m², less than 2.5 g/m², or even less than 2.0 g/m². When the fiber has a density less than 2.3 g/m², the basis weight of the non-woven fabric is less than 2.0 g/m², less than 1.4 g/m², or even less than 1.0 g/m².

### Ion-Conductive Polymer

In the present disclosure, an ion-conductive polymer is intended as a conductive polymer that uses an ion as a charge carrier. An ion-conductive polymer is generally highly polar and tends to swell in the presence of water. In a typical aspect, the ion-conductive polymer has ion-conductive groups on a side chain and the ion-conductive groups form a cluster to constitute a highly ion-conductive part, which contributes to proton transport significantly.

The ion-conductive group is preferably an acidic group from the viewpoint of providing a greater proton transport ability. From the similar viewpoint, the ion-conductive group may be a sulfonate group. In a preferred aspect, such an acidic group or a sulfonate group may be present at least at the end of the side chain of the ion-conductive polymer from the viewpoint of providing a greater proton transport ability.

In a preferred aspect, the ion-conductive polymer has a group represented by a formula —R¹SO₃Y as a side group, where R¹ is a branched or non-branched perfluoroalkyl group, perfluoroalkoxy group or perfluoroether group including from 1 to 15 carbon atoms and from 0 to 4 oxygen atoms, and Y is a proton, a cation, or a combination thereof. Among these, the sulfonate group on the side chain can significantly enhance cluster formation because its position is far removed from the main chain. Therefore, from the viewpoint of achieving the greater proton transport ability, the suitable side groups include a group represented by a formula —OCF₂CF(CF₃)OCF₂CF₂SO₃Y, —O(CF₂)₄SO₃Y, where Y is based on the same definitions as in the formula —R¹SO₃Y, and a combination thereof. The preferable example of the Y is a proton.

In a preferred aspect, the ion-conductive polymer has one or more acidic end group(s). In a preferred aspect, the acidic end group is a sulfonyl end group represented by a formula —SO₃Y, where Y is a proton, a cation, or a combination thereof.

In a preferred aspect, a main chain of the ion-conductive polymer is a fluorocarbon chain that is partially fluorinated or completely fluorinated. The suitable concentration of fluorine in the main chain may be not less than approximately 40 mass % based on the total mass of the main chain. In a preferred aspect, a main chain of the fluoropolymer is a perfluorocarbon chain.

In a preferred aspect, the ion-conductive polymer is a perfluorocarbon polymer having a side chain represented by the formula above, —R¹SO₃Y, and, in particular, a perfluorocarbon polymer having a side chain selected from the group consisting of the formula above, —OCF₂CF(CF₃)OCF₂CF₂SO₃Y, —O(CF₂)₄SO₃Y and the combination thereof.

In the ion exchange membrane of the present disclosure, the ion-conductive group (typically, a cluster of the ion-conductive groups) in a region, in which swelling is suppressed by the non-woven fabric, can contribute to better ion permeation selectivity. Meanwhile, the ion-conductive polymer in the other regions can contribute to superior proton transport by the ion-conductive groups thereof. An equivalent weight (EW, the mass of the ion-conductive polymer in grams per one equivalent ion-conductive group) of the ion-conductive group of the ion-conductive polymer used in the present disclosure is preferably not greater than approximately 1000, or not greater than approximately 850, or not greater than approximately 750 from the viewpoint of better proton transport ability, and preferably not less than approximately 600, or not less than approximately 700 from the viewpoint of greater ion permeation selectivity. The equivalent mass of the ion-conductive group can be measured by the method of back titration, in which the ion-conductive polymer is subjected to base substitution and the resultant solution is back-titrated with an alkaline solution.

Examples of the ion-conductive polymer that can be used in the present disclosure include those described in U.S. Unexamined Patent Application Publication No. 2006/0014887.

The ion-conductive polymer may be a commercially available product. Examples of commercially available products include Nafion DE2021 manufactured by DuPont (20% solution).

### Non-Woven Fabric

The non-woven fabric is disposed in the ion-conductive polymer. In one embodiment, the surface of the ion exchange membrane is configured with the ion-conductive polymer (i.e. the non-woven fabric is not exposed at the surface of the ion exchange membrane) and the non-woven fabric is present only in a partial region of the ion-conductive polymer in the thickness direction. In one embodiment, the non-woven fabric is disposed in the ion-conductive polymer, however a portion of the non-woven fabric is exposed at the surface of the ion exchange membrane. More preferably, the non-woven fabric is not exposed at the surface of the ion exchange membrane. In one embodiment, the non-woven fabric is disposed near the center of the ion-conductive polymer in the thickness direction. In another embodiment, the non-woven fabric is disposed off-center of the ion-conductive polymer in the thickness direction. For example, the non-woven fabric, having a thickness, D, is located 1D, 2D, 5D, 10D, 15D or even 20D from the surface of the ion exchange membrane in the thickness direction. The thickness of the non-woven fabric is preferably not greater than approximately 5 μm, or not greater than approximately 4.5 μm, or not greater than approximately 4 μm, or not greater than approximately 3 μm, or not greater than approximately 2 μm, from the viewpoint of better proton transport ability. In one embodiment, the average thickness of the non-woven fabric is less than 20%, less than 15%, less than 10%, less than 5%, or even less than 2% of the average thickness of the ion exchange membrane. In the ion exchange membrane of the present disclosure, the non-woven fabric is used for a special purpose of suppressing swelling of the ion-conductive polymer, which fills the pores in the non-woven fabric. In other words, it is used to control a cluster size of the ion-conductive group, which is present in the ion exchange membrane and penetrates the spacing in the non-woven fabric (pinch effect). As long as such an effect is maintained, the thickness of the non-woven fabric can be as small as possible. For this purpose, the mechanical strength of the non-woven fabric can be small compared to the case in which the non-woven fabric is used for reinforcing the ion-conductive polymer, for example. Accordingly, the smaller thickness of the non-woven fabric described above is particularly suitable for the specified application of the redox flow battery. The thickness of the non-woven fabric may be not less than approximately 1 μm from the viewpoint of superior suppression of swelling of the ion-conductive polymer. Note that, in other aspects of the present disclosure, the thickness of the non-woven fabric can be not greater than approximately 10 μm, or not greater than approximately 8 μm, or not greater than approximately 7 μm, for example, depending on the required characteristics of the redox flow battery (i.e. depending on the required proton transport ability and ion permeation selectivity of the ion exchange membrane).

In a preferred aspect, a material that configures the non-woven fabric is a non-ion-conductive polymer. Examples of the non-ion-conductive polymer include a fluorinated polymer such as polyvinylidene fluoride (PVDF) and polyvinylidene fluoride copolymer, and hydrocarbon aromatic polymer as a non-fluorinated material, such as polyphenylene oxide (PPO), polyphenylene ether sulfone (PPES), poly ether sulfone (PES), poly ether ketone (PEK), polyether ether ketone (PEEK), polyether imide (PEI), polybenzimidazole (PBI), polybenzimidazole oxide (PBIO), and a blended material thereof. Additional examples include inorganic oxides. Examples of the inorganic oxides include a material obtained from a precursor solution by sol-gel method, such as silica, alumina and titania. A mixture of the non-ion-conductive polymer and the inorganic oxide described above can be used as well. The non-woven fabric formed from these materials can be used advantageously from the viewpoint of suppression of swelling in an electrolyte solution.

In a preferred aspect, an average fiber size of the non-woven fabric is not less than approximately 150 nm, or not less than approximately 200 nm, or not less than approximately 300 nm from the viewpoint of ease of production, and not greater than approximately 800 nm, or not greater than approximately 500 nm, or not greater than approximately 300 nm from the viewpoint of ease of realizing the pore size for better swelling suppression effect of the ion-conductive polymer (cluster retention effect in particular) and ease of maintaining the proton transport ability by reducing the non-woven fabric thickness.

In a preferred aspect, a porosity of the non-woven fabric is not less than approximately 40%, not less than approximately 50% or not less than approximately 60% form the viewpoint of ease of maintaining the proton transport ability by the presence of the ion-conductive polymer in the pores of the non-woven fabric, and not greater than approximately 90% or not greater than approximately 80% or not greater than approximately 60% from the viewpoint of ease of realizing the pore size for better swelling suppression effect of the ion-conductive polymer (cluster retention effect in particular).

In a particularly preferred aspect, the non-woven fabric has a combination of the average fiber size in the specific range described above and the porosity in the specific range described above, from the viewpoint of ease of realizing the pore size for better swelling suppression effect of the ion-conductive polymer (cluster retention effect in particular).

### Production of Ion Exchange Membrane

The ion exchange membrane can be produced by various methods which enable the formation of the ion exchange membrane in a configuration of the non-woven fabric embedded in the ion-conductive polymer. Exemplary aspect of the present disclosure provides a method for producing an ion exchange membrane including:

preparing a multilayer member including a first ion-conductive polymer, a second ion-conductive polymer and a non-woven fabric including a non-ion-conductive polymer, wherein the non-woven fabric is disposed between the first ion-conductive polymer and the second ion-conductive polymer; and

forming an ion exchange membrane by subjecting said multilayer member to

(i) a temperature higher than a glass transition temperature of said first ion-conductive polymer,

(ii) a temperature higher than a glass transition temperature of said second ion-conductive polymer, or

(iii) a temperature higher than both of a glass transition temperature of said first ion-conductive polymer and a glass transition temperature of said second ion-conductive polymer.

In an exemplary aspect, an ion exchange membrane can be produced by disposing a non-woven fabric on an ion-conductive polymer (as the first ion-conductive polymer described above) by direct spinning, further disposing a fluid (e.g. a dispersion including an ion-conductive polymer and a dispersion solvent) containing the ion-conductive polymer (as the second ion-conductive polymer described above) thereon, and applying heat (to the temperature higher than the lower glass transition temperature of the first and the second ion-conductive polymers, for example). In the present disclosure, direct spinning means forming a non-woven fabric by directly depositing the material of the non-woven fabric on the ion-conductive polymer, instead of forming a non-woven fabric independently in advance. In another exemplary aspect, an ion exchange membrane can be produced by disposing a non-woven fabric formed in advance on a fluid containing an ion-conductive polymer (as the first ion-conductive polymer described above), further disposing another fluid containing the ion-conductive polymer (as the second ion-conductive polymer described above) thereon, and applying heat (to the temperature higher than the lower glass transition temperature of the first and the second ion-conductive polymers, for example). There is no difference in performance between the method of disposing a non-woven fabric formed in advance on a fluid containing an ion-conductive polymer and the method of direct spinning, as long as the structure of the ion exchange membrane produced is same. However, in the present disclosure, the thickness of the non-woven fabric introduced into the ion exchange membrane is preferably as small as possible to achieve both high proton transport ability and superior ion permeation selectivity, as long as suppression of swelling of the ion-conductive polymer (control of the cluster size of the ion-conductive groups, in particular) is effective. Thus, the non-woven fabric is preferably formed by direct spinning, considering the difficulty of handling a thin non-woven fabric that is formed independently.

The heat application described above contributes to the improvement of the mechanical strength of the ion-conductive polymer. In a preferred aspect, “the temperature higher than the lower glass transition temperature of the first and the second ion-conductive polymers” in the heat application described above can be higher than the lower glass transition temperature of the first and the second ion-conductive polymers, and not higher than (said glass transition temperature+approximately 50° C.) or not higher than (said glass transition temperature+approximately 30° C.). That is, if the lower glass transition temperature of the first and the second ion-conductive polymers is approximately 120° C., the temperature of heat application described above can be higher than approximately 120° C., or higher than approximately 120° C. and not higher than 170° C., or higher than approximately 120° C. and not higher than approximately 150° C., for example. Note that the temperature of heat application described above can be lower than or not lower than the melting point of the material configuring the non-woven fabric, as long as the fiber configuring the non-woven fabric still maintains the fiber form after the heat application described above.

The production of the ion exchange membrane by direct spinning can be done in the following steps. First, a dispersion (referred to as dispersion 1 hereinafter) containing the ion-conductive polymer and dispersion solvent is applied on a substrate of an appropriate material (e.g. polyimide, polyethylene terephthalate or polyethylene naphthalate) to form an ion-conductive polymer dispersion layer. Note that the ion-conductive polymer dispersion layer may be formed on the substrate directly. Alternatively, after an ion-conductive polymer layer is formed by applying a dispersion 2 containing an ion-conductive polymer and a dispersion solvent on a substrate and drying, the ion-conductive polymer dispersion layer may be formed by further applying the dispersion 1 on said ion-conductive polymer layer, for example. That is, the method is applicable as long as the layer to be formed, containing the ion-conductive polymer, is exposed to the underlying surface in a fluid state. The wet thickness of the ion-conductive polymer dispersion layer may be from approximately 70 μm to approximately 15 μm, or from approximately 50 μm to approximately 30 μm.

Next, a solution containing a material for forming a non-woven fabric is directly disposed on the ion-conductive polymer dispersion layer in a fiber form (i.e. direct spinning) before or after drying the ion-conductive polymer dispersion layer, to form the non-woven fabric. In a preferred aspect, electrospinning is used as a method of direct spinning. Electrospinning is advantageous from the viewpoint of relative ease of producing an ion exchange membrane containing a non-woven fabric with a smaller fiber size. The structure of the non-woven fabric (fiber size of the fiber constituting the non-woven fabric, and the thickness and the porosity of the non-woven fabric) can be controlled by adjusting the spinning conditions. For example, in electrospinning described above, the structure of the non-woven fabric can be controlled by adjusting properties of the material solution (e.g. solid concentration, viscosity, electrical conductivity, physical properties such as elasticity and surface tension, and the like) and spinning conditions such as temperature, humidity, pressure, applied voltage, injection amount of the solution, the distance from the injection part to the collector part, and collector transport speed.

Next, dispersion 3 containing an ion-conductive polymer and a dispersion solvent is further applied on the non-woven fabric in a volume corresponding to a wet thickness of from approximately 75 μm to approximately 25 μm or from approximately 60 μm to approximately 40 μm to form the ion-conductive polymer dispersion layer. As a final step, the dispersion solvent is removed by drying. By the steps described above, the ion exchange membrane, in which a non-woven fabric is disposed in an ion-conductive polymer, can be obtained.

In a preferred aspect, the dispersions 1 to 3 may contain the same or different (preferably the same) ion-conductive polymer(s) and the dispersion solvent(s). The dispersion solvent may be selected as appropriate according to the kind of the ion-conductive polymer used. For example, if the ion-conductive polymer is perfluorocarbon sulfonate polymer, the preferable dispersion solvent is ethanol/water mixture, 1-propanol/water mixture and the like.

Solid concentration of the dispersion may be adjusted so that the viscosity thereof allows the dispersion to penetrate into the pores of the non-woven fabric. The solid concentrations of the dispersion 1 and dispersion 2 can be from approximately 40 mass % to approximately 20 mass %, or from approximately 35 mass % to approximately 25 mass %, or approximately 30 mass %. The solid concentrations of the dispersion 3 can be from approximately 30 mass % to approximately 10 mass %, or from approximately 25 mass % to approximately 15 mass %, or approximately 20 mass %.

In another embodiment, the solution containing a material for forming a non-woven fabric is directly disposed on a temporary release liner (i.e., a substrate comprising a release coating) to form a non-woven fabric as described above. Next, the ion-conductive polymer dispersion is coated on top of non-woven fabric and dried to remove the dispersion solvent. The release liner is removed to form a non-woven fabric is disposed in an ion-conductive polymer.

### Membrane-Electrode Assembly

As illustrated in FIG. 1, another aspect of the present disclosure provides a membrane-electrode assembly including a positive electrode 102, a negative electrode 103, and the ion exchange membrane 101 for a redox flow battery of the present disclosure, wherein the ion exchange membrane 101 for a redox flow battery is disposed between said positive electrode 102 and said negative electrode 103.

In a typical aspect, the positive electrode and the negative electrode are porous. Carbon paper, carbon felt and the like can be used for the positive electrode and the negative electrode.

In a preferred aspect, the thicknesses of the positive electrode 102 and the negative electrode 103 are, respectively, from approximately 0.1 mm to approximately 0.5 mm and from approximately 0.2 mm to approximately 0.4 mm in the case of carbon paper, and from approximately 2 mm to approximately 7 mm and from approximately 3 mm to approximately 5 mm in the case of carbon felt.

### Redox Flow Battery

Another aspect of the present disclosure provides a redox flow battery including the membrane-electrode assembly of the present disclosure, wherein said redox flow battery includes a positive cell containing a positive electrolyte solution and said positive electrode, a negative cell containing a negative electrolyte solution and said negative electrode, and said ion exchange membrane separates said positive cell and said negative cell.

Examples of the electrolyte solution include a combination of a vanadium (IV) sulfate solution as a positive electrolyte solution and a vanadium (III) sulfate solution as a negative electrolyte solution, and a combination of manganese (Mn)-ion-containing solution as a positive electrolyte solution and a titanium (Ti)-ion-containing solution as a negative electrolyte solution. Typically, a vanadium (IV) sulfate solution as a positive electrolyte solution and a vanadium (III) sulfate solution as a negative electrolyte solution are used. In this case, oxidation reaction from vanadium (IV) to vanadium (V) in the positive cell and reduction reaction from vanadium (III) to vanadium (II) in the negative cell occur during charging and the reactions reverse to the above reactions occur during discharging.

In another aspect of the present disclosure, a redox flow battery system including a positive electrolyte solution tank for supplying a positive electrolyte solution to a positive cell, a negative electrolyte solution tank for supplying a negative electrolyte solution to a negative cell, a redox flow battery of the present disclosure, a pump for supplying the positive electrolyte solution from the positive electrolyte solution tank to the positive cell, a pump for supplying the negative electrolyte solution from the negative electrolyte solution tank to the negative cell and piping to connect above parts are provided. The positive electrolyte solution is supplied from the positive electrolyte solution tank to the positive cell and subjected to redox reaction in the positive cell, then returned back to said tank, thus being circulated between the positive cell and the positive electrolyte solution tank. The negative electrolyte solution is also circulated between the negative electrolyte solution tank and the negative cell in a similar manner. The capacities of the positive electrolyte solution tank and the negative electrolyte solution tank affect the battery capacity in the redox flow battery system, and therefore, the capacities of both tanks are designed according to the desired battery capacity.

The redox flow battery of the present disclosure can both achieve low cell resistance and high current efficiency by using the ion exchange membrane of the present disclosure.

### EXAMPLES

Exemplary aspects of the present invention will be described further hereinafter using examples, but the present invention is not limited to these examples.

### Ion-Conductive Polymer Dispersion

Ion-conductive polymer dispersion used were as follows.

Dispersion 1: Dispersion of perfluorocarbon sulfonate polymer (sulfonate group equivalent mass of 725, described in U.S. Unexamined Patent Application Publication 2006/0014887) in 30 mass % solid concentration in dispersion solvent of ethanol-water (75/25 in mass ratio) mixture.

Dispersion 2: Dispersion of perfluorocarbon sulfonate polymer (sulfonate group equivalent mass of 825, described in U.S. Unexamined Patent Application Publication 2006/0014887) in 30 mass % solid concentration in dispersion solvent of ethanol-water (75/25 in mass ratio) mixture.

Dispersion 3: Dispersion of perfluorocarbon sulfonate polymer (sulfonate group equivalent mass of 1000, described in U.S. Unexamined Patent Application Publication 2006/0014887) in 30 mass % solid concentration in dispersion solvent of ethanol-water (75/25 in mass ratio) mixture.

Dispersion 4: Dispersion of perfluorocarbon sulfonate polymer (sulfonate group equivalent mass of 725, described in U.S. Unexamined Patent Application Publication 2006/0014887) in 20 mass % solid concentration in dispersion solvent of ethanol-water (75/25 in mass ratio) mixture.

Dispersion 5: Dispersion of perfluorocarbon sulfonate polymer (sulfonate group equivalent mass of 825, described in U.S. Unexamined Patent Application Publication 2006/0014887) in 20 mass % solid concentration in dispersion solvent of ethanol-water (75/25 in mass ratio) mixture.

### Preparation of Base Membrane

Each of the Dispersions 1 to 3 was coated using a die coater onto a polyimide substrate (thickness: 50 μm) and annealed at 200° C. for 3 minutes to form Base Membranes 1 to 3, respectively. Each of Base Membranes 1 to 3 had a thickness of 20

### Preparation of Non-Woven Fabrics

The non-woven fabrics used in the samples were prepared by placing a base membrane, cut to the letter size (together with the polyimide substrate), on a drum collector of the lab-scale electrospinning device (available from Mecc Co., Ltd., Product No. NANON-03). The polyimide substrate was facing the drum. A solution of polymer was spun at various conditions directly onto the base membranes to form non-woven fabrics. After electospinning, the construction was removed from the drum and placed on a glass plate and dried under the condition of 120° C. for 10 minutes. The resulting properties of the non-woven fabrics are shown in Table 1.

For non-woven fabric 1 and 5-7, a solution (solid concentration of 12.5 mass %) of polyvinylidene fluoride (PVDF, available from Aldrich, Product Name: 347078) dissolved in dimethylformaldehydeamide/acetone (60%/40%) was used. For non-woven fabrics 2-4 and 8-10, polyvinylidene fluoride (PVDF)-hexafluoro propylene (HPF) copolymer (available from Solvay S.A., Product Name: Solef 21216) dissolved in dimethylformaldehydeamide/acetone (60%/40%) was used. Basis weight of the non-woven fabric was determined from the relationship between the amount of solution consumed in case of direct spinning on the base membrane and the actual basis weight by weight method, and was selected by adjusting the amount of the solution consumed.

### Production of Ion Exchange Membrane

### Comparative Examples 1 to 4

Each of Base Membranes 1 to 3 was cut to the letter size (together with the polyimide substrate) and placed on a flat glass plate. For Comparative Examples 1 and 2, Dispersion 1 was coated on Base Membrane 1. For Comparative Example 3, Dispersion 2 was coated on Base Membrane 2. For Comparative Example 4, Dispersion 3 was coated on Base Membrane 3. Each of the dispersions was coated onto the base membrane manually, and dried at 70° C. for 5 minutes then at 150° C. for 10 minutes. The thickness of the resulting ion exchange membrane is listed in Table 1.

### Examples 1 to 10 and Comparative Examples 5-9

For Examples 1 and 8-10, the base membrane 2 was used and for Examples 2 to 7, Base Membrane 1 was used. For Comparative Examples 5 to 6, Base Membrane 1 was used and for Comparative Examples 7-9, Base Membrane 2 was used. See Table 1 for the Non-woven Fabric used for each sample.

After electrospinning a particular non-woven fabric onto the base membrane (see the corresponding non-woven fabric and its properties in Table 1 below), a third dispersion was manually coated onto the non-woven fabric, the sample was dried at 70° C. for 5 minutes then at 150° C. for 10 minutes. Thus, the ion exchange membranes were obtained. The third dispersions used were as follows: for Examples 1 and 8-10 Dispersion 5 was used, for Examples 2 to 7 Dispersion 4 was used, and for Comparative Examples 5 and 6 Dispersion 4 was used, and for Comparative Examples 7-9 Dispersion 5 was used.

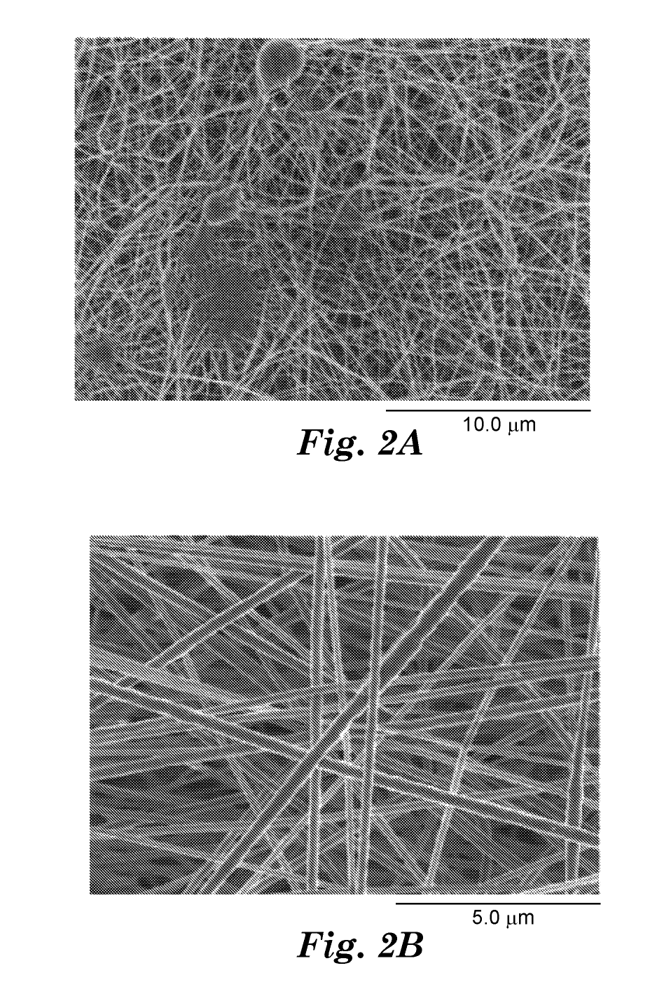

FIGS. 2A and 2B are illustrations of non-woven fabrics used in Examples and Comparative Examples. FIG. 2A illustrates the non-woven fabric 1 and FIG. 2B illustrates the non-woven fabric 4.

### Preparation of Positive Electrolyte Solution (VO₂—V4 Solution)

704.3 g of deionized water was charged into a plastic bottle and 528.5 g of 95 to 98% sulfuric acid (average 96.5%) was slowly added while monitoring the reaction temperature under ventilation. Thus, a liter of sulfuric acid solution (5.2 M) was prepared.

In a glass flask, deionized water was added slowly to 673.2 g of vanadium (IV) sulfate 3.4 hydrate (VOSO₄3.4H₂O, 3 mol, 50.94 g/mol) while stirring to make up 1 liter solution. The content of the flask was poured into a plastic bottle. The 5.2 M sulfuric acid solution above was added to the flask then added to the plastic bottle. Thus, the 2 liters of 1.5 M VOSO₄, 2.6 M H₂SO₄—V4 solution was obtained as a positive electrolyte solution.

### Preparation of Negative Electrolyte Solution (VO₂—V3 Solution)

Two plastic bottles (100 mL volume) were prepared for a positive electrolyte solution and for a negative electrolyte solution. 30 mL of V4 solution was added to each plastic bottle. The bottle was connected to a pump and a cell using piping. The liquid pump was started and the electrical cables were connected. The flow rate of the solution was set to 12 mL/min.

Open circuit voltage (OCV) was checked and the circuit was closed. Transport of the solution from the pump was confirmed. Next, the charging current of 80 mA/cm² was applied until the cell voltage reached 1.65 V. The cell voltage was held at 1.55 V until the current was reduced down to less than 2 mA/cm². At this point, the two solutions at two states were obtained in the plastic bottles. That is, the yellowish V5 solution was produced in the bottle for the positive electrolyte solution, and the greenish V3 solution was produced in the bottle for the negative electrolyte solution. Thus, the V3 solution for the negative electrolyte solution was obtained.

### Young's Modulus of Ion Exchange Membrane

Young's modulus was measured using Tensilon RTG-1325A available from Orientec Co., Ltd. The ion exchange membrane was slit to the width of 25 mm, fixed on the measurement instrument so that the effective measurement sample length was 30 mm, and measured at the strain rate of 1 mm/min.

### Total Thickness of Ion Exchange Membrane

Thickness was measured using ID-S112 Digimatic Indicator (available from Mitsutoyo Corp.). A pressure of 200 kPa was applied on the sample in the vertical direction over the tip (17 mm²) of the thickness indicator. The pressure was measured using the pressure-sensitive paper PRESCALE-ULTRA SUPER LOW (available from Fujifilm Corp.) and its dedicated analyzer FPD-100 (available from Fujifilm Corp.).

### Basis Weight of Non-Woven Fabric

The basis weights of the non-woven fabrics 1 to 10 are shown in Table 1, determined from the calibration line of basis weight vs. the amount of solution consumption by electrospinning, which had been determined in advance.

### Thickness of Non-Woven Fabric

The morphology of the cross-section of the ion exchange membrane was observed using Scanning Electron Microscope (SEM), Product No. S-4800, manufactured by Hitachi Ltd. The acceleration voltage was 3 kV. The thickness of the non-woven fabric was obtained by calculating the numerical average of measurements at 10 measurement positions selected at 2 μm interval in the 25 μm×20 μm view.

### Fiber Size of Non-Woven Fabric

The surface morphology of the non-woven fabric was observed using the SEM described above at the acceleration voltage above. The numerical average was calculated from 30 points in 3 μm×2.5 μm view. For the non-woven fabrics 1 to 10, the non-woven fabric after direct spinning was subjected to measurement.

### Porosity of Non-Woven Fabric

Porosity was calculated according to the equations below.

Mass of non-woven fabric per unit volume=(basis weight)/(thickness)

Porosity (%)=[1−(mass of non-woven fabric per unit volume)/(density of non-woven fabric material(*))]×100

(*) Density of polyvinylidene fluoride and polyvinylidene fluoride-tetrafluoro propylene copolymer (=1.78 g/cm³)

### Cell Performance Test of Redox Flow Battery

### Preparation of Cell Assembly

As a testing unit, a single serpentine flow channel, effective area 5 cm² (commercially available from Fuel Cell Technologies, Albuquerque, N. Mex.) was used. The test sample was assembled in the cell. The assembly included the ion exchange membrane and a pair of electrodes (carbon paper) in the frame gasket.

After assembly in the cell, the bolts were fastened to 110 inch/lb in a star pattern. A hard stopper for compression was set as a spacer using a gasket. The spacer was a polytetrafluoroethylene-reinforced glass fiber mesh and/or polyimide optical-grade film. The thickness was matched to the target thickness corresponding to the hard stopper for desired compression. The compression ratio was defined as the equation below.

Compression ratio (%)={1−(spacer thickness)/(carbon paper thickness)}×100

### Measurement of Cell Resistance and Current Efficiency

The cell resistance and the current efficiency were measured electrochemically using a constant-current electrolysis instrument (Iviumstat, manufactured by Ivium Technologies, Netherlands). The cell resistance is a total resistance obtained by ohmic method, from the cell voltage and the applied current density during the charging of the redox flow battery.

Two plastic bottles (100 mL volume) were prepared for the positive electrolyte solution and for the negative electrolyte solution. 30 mL of the V4 solution was added to the plastic bottle for the positive electrolyte solution, and 30 mL of the V3 solution was added to the plastic bottle for the negative electrolyte solution. The bottle was connected to a pump and a cell using tubing. The liquid pump was started and the electrical cables were connected. The flow rate of the solution was set to 12 mL/min.

The cell resistance measurement procedure during charging/discharging was as follows.

### Step 1: Initial Charging

(1-1) The cell was charged up to 1.65 V at 160 mA/cm².

(1-2) The voltage was held at 1.55 V until the current decreased down to less than 5 mA/cm².

(1-3) The cell was held at the open circuit voltage (OCV) for 30 minutes.

### Step 2: Cell Resistance Measurement

(2-1) The cell was discharged at 160 mA/cm² for 45 seconds.

(2-2) The cell was left at OCV for 180 seconds.

(2-3) Steps (2-1) and (2-2) were repeated 19 times.

(2-4) The cell was left for 180 seconds.

Step 3: Preliminary Charging/Discharging at 160 mA/Cm²

(3-1) The cell was charged up to 1.55 V at 160 mA/cm².

(3-2) The cell was discharged down to 1 V at 160 mA/cm².

Step 4: Current Efficiency Measurement at 160 mA/Cm²

(4-1) The cell was charged up to 1.55 V at 160 mA/cm².

(4-2) The cell was discharged down to 1 V at 160 mA/cm².

(4-3) Steps (4-1) and (4-2) were repeated 2 times.

The cell resistance and the current efficiency were determined by the equations below.

Cell resistance (Ω/cm²)={(OCV just before current application)−(cell voltage at the defined current density)}/(current density)

Current efficiency (%)=(time required to discharge the cell down to 1 V)/(time required to charge the cell up to 1.55 V)×100

The results are shown in Table 1, where “-” means not measured.

TABLE 1

| | Configuration of ion exchange membrane | | | | | | | | | | |
|---|---|---|---|---|---|---|---|---|---|---|---|
| | Equivalent | | | | | | | | | | |
| | mass of | | | | | | | Young's | Total | | |
| | sulfonate | | | | | | | modulus | thickness | Cell performance | |
| | group of | Nonwoven material | | | | | | of ion | of ion | (160 mA/cm²) | |
| | ion- | Non- | | Basis | | Fiber | | exchange | exchange | Cell | Current |
| | conductive | woven | | weight | Thickness | size | Porosity | membrane | membrane | resistance | efficiency |
| | polymer | fabric | Material | (g/m²) | (μm) | (nm) | (%) | (MPa) | (μm) | (Ω · cm²) | (%) |
| Example 1 | 825 | 1 | PVDF | 0.50 | 0.70 | 150 | 60 | 173 | 40 | 0.643 | 90.2 |
| Example 2 | 725 | 2 | PVDF/HFP | 0.75 | 1.26 | 300 | 67 | 181 | 30 | 0.611 | 90.0 |
| Example 3 | 725 | 3 | PVDF/HFP | 1.12 | 2.26 | 300 | 72 | — | 30 | 0.631 | 90.2 |
| Example 4 | 725 | 4 | PVDF/HFP | 2.36 | 4.25 | 300 | 69 | — | 30 | 0.608 | 89.2 |
| Example 5 | 725 | 4 | PVDF/HFP | 2.36 | 4.25 | 300 | 69 | 201 | 35 | 0.612 | 89.3 |
| Example 6 | 725 | 8 | PVDF/HFP | 1.70 | 2.14 | 150 | 55 | — | 29 | 0.543 | 88.3 |
| Example 7 | 725 | 9 | PVDF/HFP | 1.88 | 3.36 | 700 | 69 | — | 30 | 0.551 | 88.2 |
| Example 8 | 825 | 10 | PVDF/HFP | 1.70 | 1.89 | 150 | 50 | — | 31 | 0.679 | 88.6 |
| Example 9 | 825 | 11 | PVDF/HFP | 1.81 | 2.47 | 300 | 59 | — | 31 | 0.644 | 89.3 |
| Example 10 | 825 | 12 | PVDF/HFP | 1.88 | 2.67 | 700 | 60 | — | 30 | 0.664 | 90.5 |
| Comparative | 725 | none | | | | | | — | 30 | 0.543 | 87.3 |
| Example 1 | | | | | | | | | | | |
| Comparative | 725 | | | | | | | — | 42 | 0.613 | 89.0 |
| Example 2 | | | | | | | | | | | |
| Comparative | 825 | | | | | | | 182 | 32 | 0.650 | 88.6 |
| Example 3 | | | | | | | | | | | |
| Comparative | 1000 | | | | | | | — | 33 | 0.754 | 90.0 |
| Example 4 | | | | | | | | | | | |
| Comparative | 725 | 5 | PVDF | 3.64 | 6.12 | 300 | 67 | — | 30 | 0.750 | 89.8 |
| Example 5 | | | | | | | | | | | |
| Comparative | 725 | 6 | PVDF | 7.32 | 16.2 | 300 | 75 | — | 31 | 0.664 | 90.1 |
| Example 6 | | | | | | | | | | | |
| Comparative | 825 | 7 | PVDF | 4.76 | 6.67 | 500 | 60 | — | 29 | 0.652 | 89.1 |
| Example 7 | | | | | | | | | | | |
| Comparative | 825 | 7 | PVDF | 4.76 | 6.67 | 500 | 60 | — | 38 | 0.715 | 90.8 |
| Example 8 | | | | | | | | | | | |
| Comparative | 825 | 7 | PVDF | 4.76 | 6.67 | 500 | 60 | 378 | 40 | 0.725 | 89.4 |
| Example 9 | | | | | | | | | | | |

Examples 1 to 10, in which the ion exchange membrane has a non-woven fabric disposed in an ion-conductive polymer, exhibited the well-balanced cell performance of cell resistance and current efficiency.

### INDUSTRIAL APPLICABILITY

The ion exchange membrane for a redox flow battery of the present disclosure is useful in the production of a redox flow battery which can achieve both low cell resistance and high current efficiency.

### REFERENCE SIGNS LIST

11 Membrane-electrode assembly
101 Ion exchange membrane
101a Ion-conductive polymer
101b Non-woven fabric
102 Positive electrode
103 Negative electrode

1. An ion exchange membrane for a redox flow battery comprising an ion-conductive polymer and a non-woven fabric, wherein the non-woven fabric is disposed in the ion-conductive polymer and wherein the non-woven fabric has a basis weight of less than 3 g/m².

2. (canceled)

3. The ion exchange membrane for a redox flow battery of claim 1, wherein the non-woven fabric has a thickness less than 5 micrometers.

4. The ion exchange membrane for a redox flow battery of claim 1, wherein the non-woven fabric has a thickness less than 4 micrometers.

5. The ion exchange membrane for a redox flow battery according to claim 1, wherein the ion exchange membrane for a redox flow battery has a thickness of 10 μm or greater.

6. The ion exchange membrane for a redox flow battery according to claim 1, wherein the non-woven fabric has a thickness of from 0.5 μm to 4.5 μm.

7. The ion exchange membrane for a redox flow battery according to claim 1, wherein the non-woven fabric has a thickness of from 1 μm to 4 μm.

8. The ion exchange membrane for a redox flow battery according to claim 1, wherein the ion conductive polymer comprises a side group having the structure selected from the group consisting of:
—OCF₂CF₂CF₂CF₂SO₃Y,
—OCF₂CF(CF₃)OCF₂CF₂SO₃Y, and
wherein Y is a proton or a cation.

9. The ion exchange membrane for a redox flow battery according to claim 1, wherein the non-woven fabric comprises a non-ion-conductive polymer.

10. The ion exchange membrane for a redox flow battery according to claim 9, wherein the non-ion-conductive polymer comprises at least one of PVDF, PES, PEI, PBI, PPO, PEEK, PPES, PEK, and blends thereof.

11. The ion exchange membrane for a redox flow battery according to claim 1, wherein the non-woven fabric is not exposed at the surface of the ion exchange membrane.

12. The ion exchange membrane for a redox flow battery according to claim 1, wherein the average thickness of the non-woven fabric is less than 20% of the average thickness of the ion exchange membrane.

13. The ion exchange membrane for a redox flow battery according to claim 1, wherein the average fiber diameter is not greater than 300 micrometers.

14. A membrane-electrode assembly comprising a positive electrode, a negative electrode, and the ion exchange membrane for a redox flow battery described in claim 1, wherein the ion exchange membrane for a redox flow battery is disposed between the positive electrode and the negative electrode.

15. A redox flow battery comprising the membrane-electrode assembly described in claim 14, wherein the redox flow battery includes a positive cell containing a positive electrolyte solution and the positive electrode, a negative cell containing a negative electrolyte solution and the negative electrode, and the ion exchange membrane separates the positive cell and the negative cell.

16. A method for producing an ion exchange membrane for a redox flow battery comprising:
preparing a multilayer member including a first ion-conductive polymer, a second ion-conductive polymer and a non-woven fabric including a non-ion-conductive polymer, wherein the non-woven fabric is disposed between the first ion-conductive polymer and the second ion-conductive polymer; and
forming an ion exchange membrane by subjecting the multilayer member to
(i) a temperature higher than a glass transition temperature of the first ion-conductive polymer,
(ii) a temperature higher than a glass transition temperature of the second ion-conductive polymer, or
(iii) a temperature higher than both of a glass transition temperature of the first ion-conductive polymer and a glass transition temperature of the second ion-conductive polymer.
